(19) United States
(12) Patent Application Publication
(10) Pub. No.: US 2017/0185455 A1
(43) Pub. Date: Jun. 29, 2017

(54) SCHEDULER OF COMPUTER PROCESSES FOR OPTIMIZED OFFLINE VIDEO PROCESSING

(71) Applicant: Harmonic, Inc., San Jose, CA (US)

(72) Inventors: Eric Le Bars, Geveze (FR); Arnaud Mahe, Poligne (FR); David Henry, Dourdain (FR)

(21) Appl. No.: 15/382,975

(22) Filed: Dec. 19, 2016

(30) Foreign Application Priority Data
Dec. 29, 2015 (EP) 15307158.4

(51) Int. Cl. G06F 9/50; H04N 19/142; H04N 19/50; H04N 19/436; H04N 21/241; H04N 19/177; H04N 21/262

(52) U.S. Cl. CPC G06F 9/5044; H04N 19/177; H04N 19/142; H04N 21/262; H04N 19/436; H04N 21/241; H04N 19/50

(57) ABSTRACT

A scheduler of video processes to be run on a cluster of physical machines. The scheduler splits video content into a plurality of video sequences based on at least one of a scene cut detection, a minimum duration, or a maximum duration. The video sequences are to be encoded on Operating-System-Level virtual environments in parallel. The scheduler also calculates, for each video sequence, based at least in part on the video sequence and a target coding time of the video content, a target computing capacity of an Operating-System-Level virtual environment to code the video sequence. The scheduler may also create, for each video sequence, an Operating-System-Level virtual environment having the target computing capacity to be instantiated on a physical machine in the cluster of physical machines.

### CLAIM OF PRIORITY

This application claims priority to European Patent Application Serial No. 15307158.4, filed on Dec. 29, 2015, entitled “Scheduler of Computer Processes for Optimized Offline Video Processing,” invented by Eric Le Bars et. al., the disclosure of which is hereby incorporated by reference in its entirety for all purposes as if fully set forth herein.

### FIELD OF THE INVENTION

Embodiments of the invention generally relate to the management of virtual machines and video processes.

### BACKGROUND

In computing, a virtual machine (VM) is an emulation of a particular computer system. Virtual machines may operate based on the computer architecture and functions of a real or a hypothetical computer. Implementing a virtual machine may involve specialized hardware, software, or both.

Virtual machines may be classified based on the extent to which they implement functionalities of targeted real machines. System virtual machines (also known as full virtualization VMs) provide a complete substitute for the targeted real machine and a level of functionality required for the execution of a complete operating system. In contrast, process virtual machines are designed to execute a single computer program by providing an abstracted and platform-independent program execution environment.

The use of VMs provides flexibility in the handling of tasks to execute in parallel. VMs can be created and deleted very easily to meet the needs of task processing that evolve in real time. In multimedia processing, VMs provide great flexibility for creating machines with desired properties, since the actual characteristics of a VM are a combination of software characteristics and characteristics of the physical machine on which the VM is executed.

In a multimedia head-end server, a plurality of machines, whether they be virtual or physical, are usually available. When a plurality of tasks is to be executed on a plurality of machines, an orchestrator may be used to dispatch the performance of the tasks amongst the machines. Tasks may be created, executed, then ended, and the orchestrator will allocate a task to a machine for its execution.

The use and deployment of VMs is particularly suited for computationally-intensive tasks, such as video encoding or transcoding.

The development of VOD (Video on Demand) services enhanced the need for VM use in video encoding or transcoding. Indeed, many video programs are available on demand on dedicated platforms. For example, some TV channels have a website where each episode of the news, weather reports, or other such TV shows is available soon after the program has been broadcast.

In order to provide the best possible service to customers, large video files are typically encoded to have the best possible quality in the least amount of time. In order to achieve this goal, video encoding may be performed using a plurality of VMs dispatched on a cluster of physical machines. To do so, a dispatcher may split the video content to be encoded into a plurality of video sequences of equal sizes. Then, the dispatcher creates, for each resulting video sequence, a predefined VM that is configured to perform video encoding. Each video sequence is then encoded in parallel by a separate VM. Dispatching video encoding tasks between a plurality of VMs enables the video encoding time to be reduced.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 displays a general overview of a cluster of physical machines and a scheduler of video processes in accordance with an embodiment of the invention;

FIG. 2 displays an exemplary architecture of a scheduler of video processes in accordance with an embodiment of the invention;

FIG. 3 displays an example of dynamic adaptation of resources of virtual machines by a scheduler of video processes in accordance with an embodiment of the invention;

FIGS. 4a and 4b display two examples of splits of video contents into a plurality of video sequences in accordance with an embodiment of the invention; and

FIG. 5 is a flowchart depicting the steps of scheduling video processes to be executed on a cluster in accordance with an embodiment of the invention.

### DETAILED DESCRIPTION OF THE INVENTION

Approaches for scheduling video processes amongst VMs are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention. Embodiments of the invention may be used in relation with any type of Operating-System-Level virtual environment, such as Linux containers for example.

Note that examples herein will be discussed with reference to encoding digital video. Any such example or discussion involving encoding shall apply and be equally applicable to decoding or transcoding. However, for clarify, embodiments of the invention shall chiefly be described with reference to encoding, but note that embodiments may apply, mutatis mutandis, to decoding and transcoding techniques.

### Functional Overview

While video encoding may be performed using a plurality of VMs dispatched on a cluster of physical machines, the manner in which the prior art has typically done so is observed to have significant drawbacks. When a video file is split into smaller video sequences of equal size, the separation of video sequences does not necessarily occur at a scene change. As a result, encoding a video sequence will likely begin with a Group of Pictures (GOP) that is in the middle of a scene.

It is possible to split video content at scene cuts and dispatch the different video sequences, which correspond to different scenes of the video content, to predefined VMs. Unfortunately, the coding time of video sequences is unpredictable given the diversity in video complexity between different video sequences. More complex scenes, such as waves in the water or explosions, are more time consuming to encode than simpler scenes.

As a result, when encoding such video sequences in parallel, encoding time between the split video sequences will, in all likelihood, not be balanced and the resources of the cluster on which the virtual machines execute will likely not be optimized. The total encoding time of the video content will be the encoding time of the longest/most complex scene, even if all other scenes are much faster to encode.

A virtual machine executing in a physical machine reserves a nominal amount of resources in the physical machine even when the virtual machine is inactive. Resources reserved for an inactive virtual machine cannot be used for other purposes. Therefore, all virtual machines but the single virtual machine (the “longest processing VM”) responsible for encoding the longest and/or most complex scene will finish encoding their assigned video sequences before the longest processing VM has finished encoding its assigned work. As can be appreciated, all virtual machines but for the longest processing VM will have reserved resources which will go unused or underutilized while the longest processing VM finishes completion of its assigned work. These unused resources have an important impact on financial cost of the system, as unused resources contribute to the cost of supporting extra resources than necessary in a clusters of machines, the cost of extra machines in the cluster, and the cost of excessive consumption of electricity for running and cooling these physical machines.

Embodiments of the invention advantageously provide for a scheduler of video processes that encode or transcode video content. A schedule of an embodiment allocates video processing tasks amongst a number of virtual machines that each execute on a node of a cluster of physical machines. The virtual machines operate in parallel to encode or transcode video at an optimal quality/rate ratio. Embodiments ensure that all virtual machines execute their video processing tasks in a comparable timeframe.

### Architecture Overview

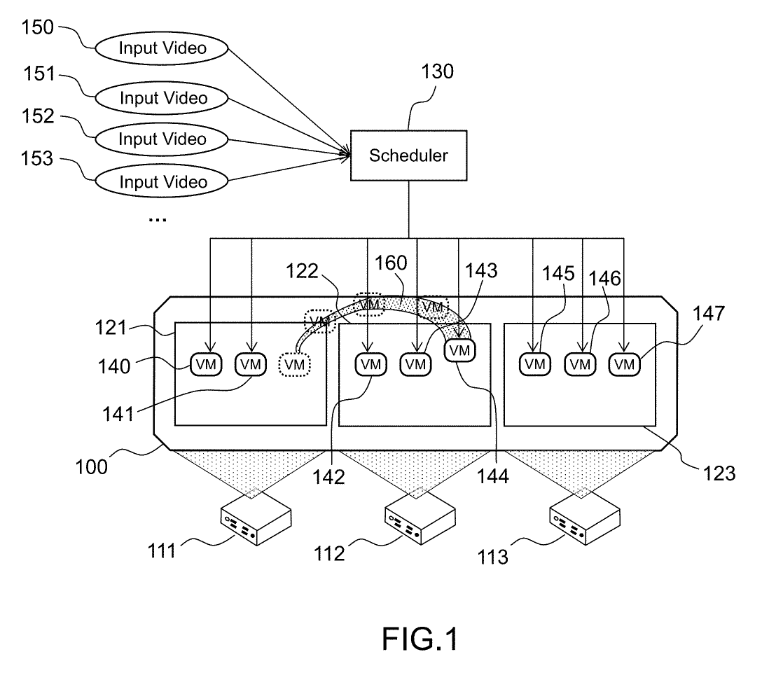

FIG. 1 displays a general overview of a cluster 100 of physical machines and a scheduler of video processes in accordance with an embodiment of the invention. Cluster 100 comprises three physical machines 111, 112, and 113. Each physical machine 111, 112, 113 is associated with a VM host, respectively hosts 121, 122, and 123. Each VM host is responsible for reserving a portion of resources of a physical machine to a VM and executing the VM using the reserved resources.

Scheduler 130 is configured to create and allocate tasks involving in processing one or more input videos 150, 151, 152, 153. Each of the one or more input videos 150, 151, 152, 153 may correspond to a video file or a video stream. Scheduler 130 is responsible for balancing the computing load amongst VMs in cluster 100. Scheduler 130 may create a plurality of video encoding or transcoding processes, create or configure one or more VMs to execute such processes, and dispatch/instantiate such VMs onto the physical machines of cluster 100.

In the example of FIG. 1, scheduler 130 created 8 VMs 140, 141, 142, 143, 144, 145, 146, and 147. In embodiments of the invention, the processes running on the VMs are pure video encoding or video transcoding processes, and other multimedia tasks such as multiplexing/demultiplexing, audio encoding, DRM (Digital Right Management) are performed by other processes running in other VMs. According to other embodiments, a process running on a VM performs all multimedia tasks for a video sequence, such as video encoding/transcoding, audio encoding/transcoding, multiplexing/demultiplexing, and the like.

When a VM is allocated onto a physical machine, a part of the resources of the physical machine is reserved for the VM. This includes, for example, a reservation of CPU, a reservation of RAM, and a reservation of bandwidth on a network. Naturally, the sum of resources reserved for the VMs running on the same physical machine cannot exceed the resources of the physical machine on which the VM executes. Thus, the resources allocated to each VM shall be specifically tailored to be able to execute the processes handled by the VM in due time, while not wasting resources of the physical machine, and ensuring that all VMs on a physical machine can execute properly.

To do so, scheduler 130 is able to define, at the creation of each VM, the resources to allocate to new VM, modify at any time the resources allocated to the VM, or re-allocate a VM to another machine, for example reallocate (160) VM 144 from physical machine 121 to physical machine 122.

In an embodiment, scheduler 130 may be part of a VOD (Video on Demand) device, and may be responsible to encode/transcode videos programs, either in a deterministic time or shortest time possible, with the additional constraint of providing the best quality of service which matches the needs of customers.

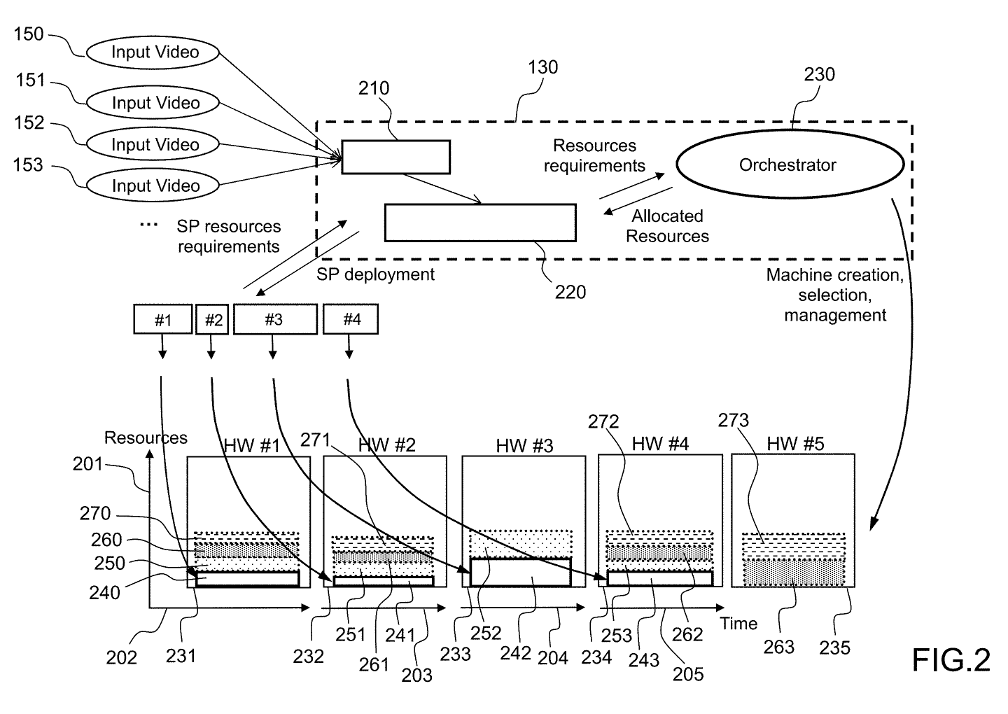

FIG. 2 displays an exemplary architecture of a scheduler of video processes according to an embodiment of the invention. Scheduler 130 comprises a first processing logic 210, a second processing logic 220, and a third processing logic 230. According to various embodiments of the invention, first processing logic 210, second processing logic 220 and third processing logic 230 may be embedded in or running on two different processing machines, or on a single processing machine configured with two different sets of code instructions. Further, first processing logic 210, second processing logic 220 and third processing logic 230 may be implemented in a variety of different manner, such as by a single software entity or by multiple software entities arranged differently than depicted in the example of FIG. 2. In the example of FIG. 2, the cluster of physical machines comprises five physical machines, namely physical machines 231, 232, 233, 234, and 235. A virtual machine may be instantiated and executed on one of the physical machines of the cluster of physical machines.

First processing logic 210 is responsible for splitting video content into a plurality of video sequences based on at least one of a scene cut detection, a minimum duration, and a maximum duration. The video sequences split from the video content are to be encoded on Operating-System-Level virtual environments that execute in parallel. For example, input video 150 may be split into four video sequences. Each of the four video sequences split from input video 150 may be encoded, respectively, by VMs 240, 241, 242, and 243, where each of these four VMs execute in parallel. Input video 151 may be split into four video sequences, respectively encoded by VMs 250, 251, 252, and 253 in parallel. Input video 152 may be split into four video sequences, respectively encoded by VMs 260, 261, 262, and 263 in parallel. Input video 153 may also be split into four video sequences, respectively encoded by VMs 270, 271, 272, and 273 in parallel.

In the example of FIG. 2, each VM that is responsible for a different video sequence split from the same input video executes on a separate physical machine. However, embodiments may allocate two or more VMs to encode different video sequences split from t the same input video on the same physical machine.

As shown in FIG. 2, vertical axis 201 represents the amount of resources reserved by a physical machine. When a VM is allocated onto (i.e., instantiated) a physical machine, the resources corresponding to the computing capacities of the VM are reserved by the physical machine. The heights of rectangles 240 to 243, 250 to 253, 260 to 263, 270 to 273 represent the computing capacities of these VMs. The resource and computing capacities represented by the vertical axis may correspond to any resource, such as CPU, memory, bandwidth, or a combination thereof.

In FIG. 2, horizontal axis 202, 203, 204, 205 represents time for a physical machine. Horizontal axis 202, 203, 204, 205 thus show the evolution of computing capacities of VMs 240 to 243, 250 to 253, 260 to 263, 270 to 273 over time. In the example of FIG. 2, once the computing capacities of VMs 240 to 243, 250 to 253, 260 to 263, 270 to 273 are established, those computing capacities are not changed afterwards.

Since video sequences split from an input video are encoded, transcoded, or decoded in parallel, splitting the video sequences based on scene cut detection delivers optimal quality, since each video sequence begins with an intra-frame. Indeed, when the video sequences are cut in the middle of a scene, the video encoder is forced to insert an intra-frame in the middle of a scene. Thus, a number of video frames will not fully benefit from motion estimation of nearby frames when they belong to another sequence. Thus, the quality of the video is lowered if the video sequences are not separated at scene cuts.

In addition, establishing a minimum and a maximum duration of a split video sequence is also advantageous. Having a minimum duration prevents the scheduler from creating a VM that is responsible for processing a very low number of frames, as would be the case if the split video sequence is short in length. Establishing and enforcing a maximum duration prevents a virtual machine from being assigning a processing task that requires an excessively long time to process, even if the processes resources to complete the task are available to the virtual machine. Any maximum duration established and enforcement should be long enough that it permits the desirable level of quality in video processing. Indeed, even if the maximum duration requires that a video sequence be split from an input video in the middle of the scene, assuming the maximum duration is long enough, some intra-frames would have already been included by the encoder in the scene in order to avoid GOPs (Groups Of Pictures) having an excessive duration, which are known to diminish video quality.

According to various embodiments of the invention, the minimum and maximum duration may be expressed in seconds, milliseconds, in number of frames, or by any metrics which allows a determination of the boundaries of the video sequences.

Many embodiments allow for separating the input video into video sequences based on scene cut detection, minimum duration, maximum duration, or any combination thereof. In a number of embodiments, first processing logic 210 is configured to split video content into a plurality of video sequences based on at least one of a scene cut detection, after a minimum duration, and before a maximum duration.

For example, first processing logic 210 may be configured to separate input video into video sequences at each scene cut. Doing so in advantageous towards maximizing video quality, since the video encoder will not be forced to insert an intra-frame within a scene.

First processing logic 210 may also be configured to verify if a scene cut is present in an interval between a minimum and a maximum duration established from a start of the video content, or a start of the video content which has not been sequenced. If there is a scene cut between any established minimum and maximum duration, then first processing logic 210 will trigger creation of a video sequence from the start of the video content, or the start of the video content which has not been sequenced, and the scene cut. However, if there is not a scene cut between any established minimum and maximum duration, then first processing logic 210 may trigger creation of a video sequence from the start of the video content, or the start of the video content which has not been sequenced, with a duration equal to the maximum duration. Thus, the sequences are separated at scene cuts as often as possible, and if that is not possible, then the longest possible sequences are created, thereby minimizing the number of separation of sequences in the middle of a scene. In embodiments using finely tuned parameters, a good compromise may be reached between video quality and consistency in the duration of the sequences.

Second processing logic 220 is configured to calculate, for each video sequence split from an input video, based on the video sequence and a target coding time of the video content, a target computing capacity of an Operating-System-Level virtual environment to code (i.e., encode, transcode, or decode) the video sequence. Advantageously, second processing logic 220 is configured to calculate computing capacities of Operating-System-Level virtual environment in order that the coding times (i.e., the time required to encode, transcode, or decode the video sequence) of each video sequence are as close as possible. Thus, the coding all video sequences can be performed nearly at the same time. According to various embodiments of the invention, the computing capacities may be a CPU power, an amount of memory, a bandwidth, or a combination thereof. More generally, the computing capacities may refer to any resource of a VM which has an effect on video coding speed.

In a number of embodiments of the invention, second processing logic 220 is configured to calculate the processing capability that allows coding a video sequence within a target coding time, based on a duration of the video sequence, a parameter of the complexity of the video sequence, or a combination thereof.

For example, second processing logic 220 may be configured to calculate the computing capacities necessary to code the video sequence within the target coding time based on the duration and the resolution of the video or the number of frames and the resolution of the video. Second processing logic 220 may also take into account complexity parameters such as a level of movement in the sequence, a level of detail of the images in the sequence, an evaluation of the textures of the sequence, and the like. Indeed, it is known that video sequences with fast movements are more difficult to code than quiet ones. It is also known that video sequences with complex textures such as water are more difficult to code than simpler textures, and that videos with lots of details are more difficult to code than videos with fewer details.

Thus, in an embodiment, second processing logic 220 may advantageously tailor the processing capabilities of the VM in order that they encode their respective video sequence at about the same time, according to the duration, resolution, complexity of the sequence, or according to any other parameter which has an effect on the coding time of a video sequence.

In a number of embodiments of the invention, second processing capability 220 is also configured to calculate the computing capabilities necessary to code the video sequence in the target coding time based on a target index of quality of the video, a target bitrate of a video codec, or a combination thereof. Indeed, it is known that, at an equivalent bitrate, it is more complex to code video at a higher quality. Meanwhile it is also known that some video codecs are more computationally intensive than others. Possible target indexes of quality may be, for example, a PSNR (Peak Signal Noise Ratio), SSIM (Structural SIMilarity), MS-SSIM (Multi-Scale Structural SIMilarity), Delta, MSE (Mean Squared Error), or any other standard or proprietary index. When applicable, such an index may be computed on the video as a whole, or a layer of the video, for example one of the R,G,B layer of the RGB colorspace, one of the Y,U,V layer of a YUV colorspace, or any layer or combination of layers of a type of colorspace. Possible video codecs may be any standard or proprietary video codec, for example the H.264/AVC (Advanced Video Codec), H.265/HEVC (High Efficiency Video Codec), MPEG-2 (Motion Picture Experts Group), VP-8, Vp-9, and VP-10. Indeed, embodiments of the invention may be implemented without reference to the coding scheme.

Determining the computing capacities necessary to execute video coding successfully may be achieved in various way by embodiments. For example, European patent application No. 15306385.4, entitled “Method for Determining a Computing Capacity of One of a Physical Machine or a Virtual Machine,” filed by the Applicant on Sep. 11, 2015, discloses a method to determine a computing capacity of a computing machine, using calibrated computer processes, and a method to calculate a computing load of calibrated computed process using a reference computing machine. Embodiments of the invention may use this approach for determining the computing capacities necessary to execute video coding successfully.

In a number of embodiments of the invention, a computing load of a video encoding process is calculated by running a plurality of instances of the process on a reference machine having known computing capacity while each of the instances is able to execute successfully, and thus, determining the maximum number of instances of the elementary process that can successfully run in parallel on the reference machine. The computing load of the video encoding process can then be calculated as the computing capacity of the reference machine divided by the maximum number of instances of the elementary process that can successfully run in parallel.

In a number of embodiments of the invention, the computing loads of a number of reference video encoding/transcoding processes are calculated, for different durations, resolutions, video complexities and different target qualities. It is then possible to infer, using both reference computing loads of reference video encoding/transcoding processes, and the characteristics of the video sequence to code, corresponding computing loads of the video encoding processes, and to calculate the computing capabilities of the VM accordingly.

In a number of embodiments of the invention, second processing logic 220 is configured to calculate processing capacities of the VMs in order to code the video sequences in a predefined target computing time. Such an approach is useful if the video needs to be coded within a given time, such as to facilitate broadcast of the video.

In other embodiments of the invention, second processing logic 220 is configured to calculate processing capabilities of the VMs in order to code the video sequences in a coding time which depends on characteristics of a reference video sequence. For example, if an input video needs to be coded as fast as possible, then second processing logic 220 may be configured to determine the coding time of the video sequence which is the longest to code, which will likely correspond to the longest and/or the most complex video sequence, using the most powerful VM available. This coding time will be established by second processing logic 220 as the target coding time, and thereafter, second processing logic 220 will calculate, based on the target coding time and the characteristics of all video sequences, the processing capabilities for the VMs.

In yet other embodiments of the invention, second processing logic 220 may be configured to calculate the processing capabilities of the VMs directly using a proportionality coefficient between processing capabilities of VMs and durations and/or indexes of the complexity of the video sequences.

For example, a CPU CPUᵢ of a VM VMᵢ to code a sequence i could be calculated based on the duration dᵢ of the sequence to be coded by VMᵢ, based on the maximum CPU CPUₘₐₓ that the scheduler can allocate and the duration dₘₐₓ of the longest sequence by a formula of the type:

$$CPUi = \frac{CPU max * di}{d max}$$

Thus, the highest possible CPU is allocated to the VM coding the longest video sequence, and a CPU proportional to the duration of each sequence is allocated to the VM that code each sequence. Such an embodiment has the advantage of offering a very simple way of defining the CPU of each VM in order to code the entire input video as fast as possible. As video sequences split from the same input video usually have the same resolution and target quality, this approach provides a good compromise between efficiency and simplicity.

Embodiments may also use an equivalent formula for each computing capacity. Second processing logic 220 may also be configured to calculate the CPU resources required by each VM using both the duration and an index of complexity of the video sequence to be processed by that VM. Thus, the formula becomes:

$$CPUi = \frac{CPU max * di * Ci}{d max * C max}$$

where Ci is a complexity index of the sequence i, and dmax and Cmax are respectively the duration and complexity index of a reference sequence, for which the factor di*Ci is the highest.

This embodiments provides an even better measure of the CPU resources to allocate to each VM. In this example, the indexes Ci and Cmax are indexes of the complexity of each video sequence based on characteristics of the video sequences such as the level of details, the types of textures, the level of movements, and the like. In this example, the video sequence being associated to the most powerful machine is not necessary the longest, but a video sequence which is considered as the longest to code, based both on the duration of the sequence, and the relative complexity of the video within the sequence.

In a number of embodiments, third processing logic 230 is configured to create and allocate the VMs on physical machines based on the computing capabilities calculated by second processing logic 220.

In a number of embodiments of the invention, third processing logic 230 is configured to allocate or instantiate a VM onto the physical machine that has the largest amount of resources available. This favors a balanced dispatching of the computing load amongst the physical machines.

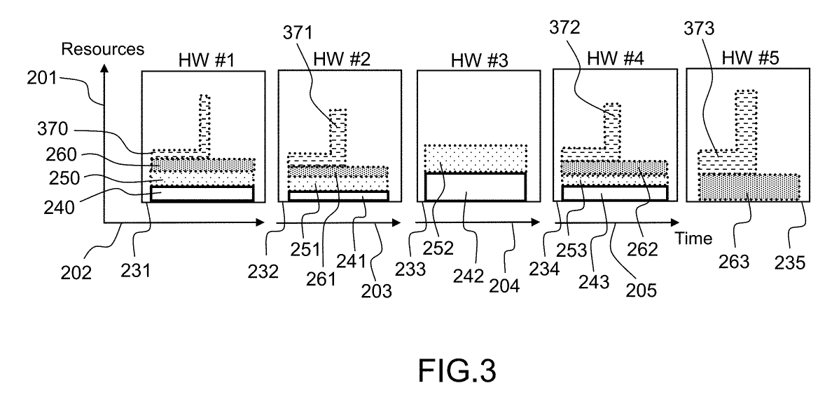

FIG. 3 displays an example of dynamic adaptation of resources of virtual machines by a scheduler of video processes in accordance with an embodiment of the invention.

In a number of embodiments of the invention, scheduler 130 is further configured to modify the resources allocated or assigned to one or more VMs upon a modification of a target coding time, for example, the target coding time of one of the input videos 150, 151, 152 and 153. For example, such modification may occur if the video needs to be delivered earlier or later than the initially expected time.

Upon a modification of a process, second processing logic 220 is configured to re-calculate the processing capabilities of the VMs executing the coding processes of the video sequences of the input video whose target coding time changed. This may be done in different ways according to various embodiments of the invention.

In an embodiment of the invention, second processing logic 220 is configured to calculate, for each video sequence, the remaining duration or number of frames to code, and calculate, based on the remaining duration and number of frames to code, the corresponding processing capabilities, similarly to the initial calculation described with reference to FIG. 2.

In other embodiments of the invention, a proportionality coefficient is calculated between the previously remaining target coding time, the new remaining target coding time, the initial processing capabilities, and the new processing capabilities. To illustrate, for a video sequence i, second processing logic 220 can be configured to calculate an updated CPU CPU2 of the VM coding the video sequence based on the initial CPU CPU1 of this VM, by a formula of the type:

CPU2=CPU1*(t_{end1}−t)/(t_{end2}−t)

where t_{end1} is the initial target coding time, t_{end2} is the updated target coding time, and t is the elapsed coding time. Thus, the CPU capabilities of the VM are updated proportionally to the increase or decrease of the remaining target coding time.

First processing logic 210 may be configured to indicate these changes to second processing logic 220, which in turn may be configured to modify the resources of the VMs accordingly.

FIG. 3 displays the result of a modification of the target coding time of input video 153 according to an embodiment of the invention. The target coding time of this input video has been set to an earlier end time. Thus, the remaining coding time is less than originally anticipated; in response, second processing logic 220 is configured to re-calculate and increase the computing capacities of VMs 270, 271, 272, 273 in order that they are able to encode their respective video sequences by the new target time. Diagrams 370, 371, 372 and 373 show the evolution of computing capacities of the VMs 270, 271, 272, 273 over time. The processing capabilities of the four VMs are increased at the same time. Thus, all video sequences of input video 153 are coded earlier and the whole video is successfully coded by the new target time.

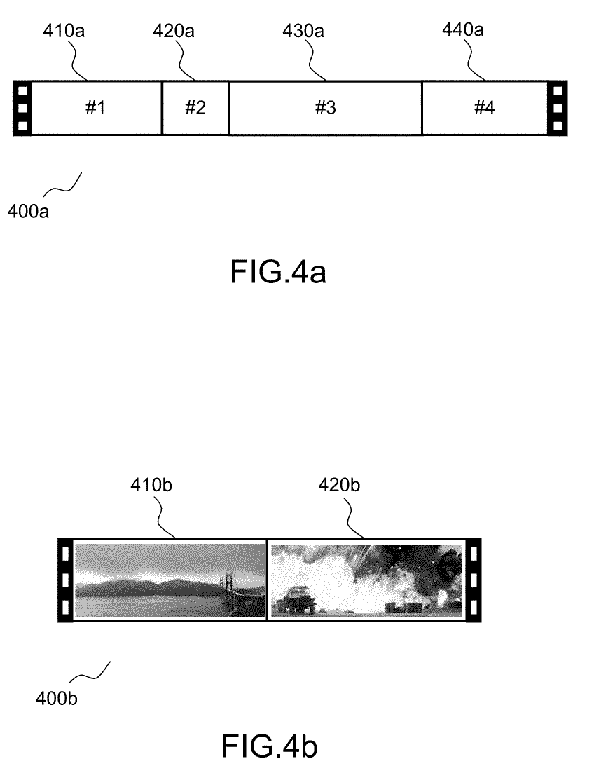

FIGS. 4a and 4b display two examples of splitting video contents into a plurality of video sequences in accordance with an embodiment of the invention. FIG. 4a displays a first example of splitting video content 400a into four video sequences, namely video sequences 410a, 420a, 430a and 440a.

The four video sequences 410a, 420a, 430a, and 440a have different duration due to the differences of durations of the scenes of the input video content. In this example, second processing logic 220 may be configured to calculate computing capabilities of the VMs which will respectively execute the processes to code (either encode, transcode, or decode) video sequences 410a, 420a, 430a, and 440a based at least on the duration of the sequences in order that the coding time of the four sequences is similar.

FIG. 4b displays a second example of splitting a video content 400b into two video sequences 410b and 420b in accordance with an embodiment of the invention. In the example of FIG. 4b, the two video sequences 410a and 420a have identical durations, but video sequence 420b is much harder to code than video sequence 410b. Indeed, video sequence 410b represents a very quiet landscape, with few details, contrasts and movements. On the other hand, sequence 420b displays lots of movements, explosions, details and complex textures. Thus, even with the same duration, sequence 420b is much more complex and time-consuming to code to obtain the same quality/rate ratio. Indeed, such a complex video sequence requires more complex motion estimation and prediction techniques to be coded with a good quality/rate ratio. Thus, in this example, second processing logic 220 may be configured to calculate computing capabilities of the VMs which will execute the processes to code respectively video sequences 410b and 420b based at least on an index of complexity of the video sequences in order that the coding time and output quality of the two sequences is similar.

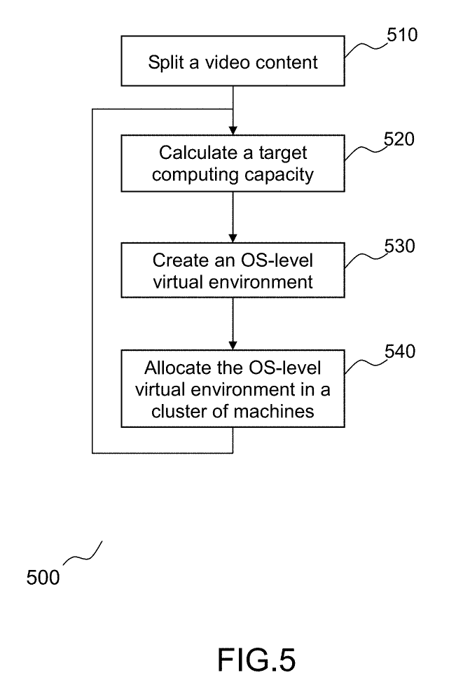

FIG. 5 is a flowchart illustrating steps for scheduling video processes to be executed on nodes of a cluster of physical machines in accordance with an embodiment of the invention. Flowchart 500 comprises a step of splitting 510 video content into a plurality of video sequences based on at least one of a scene cut detection, a minimum duration, and a maximum duration, where all video sequences in the video content to be encoded on Operating-System-Level virtual environments running in parallel.

Method 500 further comprises a step 520 of calculating for each video sequence, based on the video sequence and a target coding time of the video content, a target computing capacity of an Operating-System-Level virtual environment to code the video sequence.

Method 500 further comprises a step 530 of creating, for each video sequence, an Operating-System-Level virtual environment of the target computing capacity.

Method 540 further comprises a step 540 of causing an allocation of the Operating-System-Level virtual environment to a physical machine in the cluster of physical machines.

Many different embodiments of a method 500 of the invention are possible, and all embodiments of a scheduler 130 of the invention are applicable to a method 500 of the invention.

Advantageously, embodiments of the invention enable to coding time of video content using a plurality of virtual machines to be more deterministic. Further, embodiments improve the usage of hardware resources in a cluster of physical machines, including optimizing the allocation of hardware and software resources. Embodiments also reduce the number of physical machines necessary to deliver an equivalent level of service as prior art solutions, thereby saving electrical power.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A non-transitory computer-readable storage medium storing one or more sequences of instructions for scheduling execution of video processes on a cluster of physical machines, which when executed, cause:
splitting video content into a plurality of video sequences based on at least one of: a scene cut detection, a minimum duration, and a maximum duration, wherein said plurality of video sequences are to be coded on Operating-System-Level virtual environments executing in parallel;
calculating, for each video sequence, based on the video sequence and a target coding time of the video content, a target computing capacity of an Operating-System-Level virtual environment to code said each video sequence; and
instantiating, for each video sequence, an Operating-System-Level virtual environment of the target computing capacity on a physical machine in the cluster of physical machines.

2. The non-transitory computer-readable storage medium of claim 1, wherein calculating the target computing capacity is based, at least in part, upon a reference video sequence and a ratio of a parameter representative of said each video sequence and a parameter representative of the reference video sequence.

3. The non-transitory computer-readable storage medium of claim 2, wherein said parameter representative of said each video sequence is a duration of the video sequence, a parameter representative of the complexity of the video sequence, or a combination thereof, and the parameter representative of the reference video sequence is a duration of the reference video sequence, a parameter representative of the complexity of the reference video sequence, or a combination thereof.

4. The non-transitory computer-readable storage medium of claim 2, wherein execution of the one or more sequences of instructions further cause:
calculating a parameter representative of said each video sequence; and
selecting a particular video sequence, of said plurality of video sequences, having one of a minimum and a maximum parameter as the reference video sequence.

5. The non-transitory computer-readable storage medium of claim 1, wherein calculating, for each video sequence, the target computing capacity of an Operating-System-Level virtual environment is performed, at least in part, based on the target coding time of the video content and a duration of the video sequence, a parameter representative of the complexity of the video sequence, or a combination thereof.

6. The non-transitory computer-readable storage medium of claim 5, wherein the duration of the video sequence is expressed in one of seconds, milliseconds, and number of frames.

7. The non-transitory computer-readable storage medium of claim 5, wherein the target coding time of the video content is a predefined target computing time.

8. The non-transitory computer-readable storage medium of claim 5, wherein the target coding time of the video content is calculated based on a duration of a reference video sequence, a parameter representative of the complexity of the reference video sequence, or a combination thereof, and a reference computing capacity of an Operating-System-Level virtual environment.

9. The non-transitory computer-readable storage medium of claim 8, wherein said reference video sequence is one or more of a longest a most complex video sequence in the plurality of video sequences, and wherein the reference computing capacity is equal to the highest computing capacity of any created Operating-System-Level virtual environment for said video content.

10. The non-transitory computer-readable storage medium of claim 1, wherein splitting video content into a plurality of video sequences further comprises:
splitting the video content into the plurality of video sequences so that boundaries of each video sequence, of the plurality of video sequences, occurs at each scene cut.

11. The non-transitory computer-readable storage medium of claim 1, wherein execution of the one or more sequences of instructions cause iteratively creating video sequences by:
verifying whether a scene cut is present in an interval between the minimum and the maximum duration from a start of the video content or a start of the video content which has not been sequenced;
upon determining that the scene cut is present, creating a video sequence from the start of the video content, or the start of the video content which has not been sequenced, and the scene cut; and
upon determining that the scene cut is not present, creating the video sequence from the start of the video content, or the start of the video content which has not been sequenced, with a duration equal to the maximum duration.

12. The non-transitory computer-readable storage medium of claim 1, wherein execution of the one or more sequences of instructions cause:
upon a modification of the target coding time of the video content, modifying the computing capacities of all or a part of Operating-System-Level virtual environments based on the modification of the target coding time.

13. An apparatus for scheduling execution of video processes on a cluster of physical machines, comprising:
one or more processors; and
one or more non-transitory computer-readable storage mediums storing one or more sequences of instructions, which when executed, cause:
splitting video content into a plurality of video sequences based on at least one of: a scene cut detection, a minimum duration, and a maximum duration, wherein said plurality of video sequences are to be coded on Operating-System-Level virtual environments executing in parallel;
calculating, for each video sequence, based on the video sequence and a target coding time of the video content, a target computing capacity of an Operating-System-Level virtual environment to code said each video sequence; and
instantiating, for each video sequence, an Operating-System-Level virtual environment of the target computing capacity on a physical machine in the cluster of physical machines.

14. The apparatus of claim 13, wherein calculating the target computing capacity is based, at least in part, upon a reference video sequence and a ratio of a parameter representative of said each video sequence and a parameter representative of the reference video sequence.

15. The apparatus of claim 14, wherein said parameter representative of said each video sequence is a duration of the video sequence, a parameter representative of the complexity of the video sequence, or a combination thereof, and the parameter representative of the reference video sequence is a duration of the reference video sequence, a parameter representative of the complexity of the reference video sequence, or a combination thereof.

16. The apparatus of claim 14, wherein execution of the one or more sequences of instructions further cause:
calculating a parameter representative of said each video sequence; and
selecting a particular video sequence, of said plurality of video sequences, having one of a minimum and a maximum parameter as the reference video sequence.

17. The apparatus of claim 13, wherein calculating, for each video sequence, the target computing capacity of an Operating-System-Level virtual environment is performed, at least in part, based on the target coding time of the video content and a duration of the video sequence, a parameter representative of the complexity of the video sequence, or a combination thereof.

18. The apparatus of claim 17, wherein the duration of the video sequence is expressed in one of seconds, milliseconds, and number of frames.

19. The apparatus of claim 17, wherein the target coding time of the video content is a predefined target computing time.

20. The apparatus of claim 17, wherein the target coding time of the video content is calculated based on a duration of a reference video sequence, a parameter representative of the complexity of the reference video sequence, or a combination thereof, and a reference computing capacity of an Operating-System-Level virtual environment.

21. The apparatus of claim 20, wherein said reference video sequence is one or more of a longest a most complex video sequence in the plurality of video sequences, and wherein the reference computing capacity is equal to the highest computing capacity of any created Operating-System-Level virtual environment for said video content.

22. The apparatus of claim 13, wherein splitting video content into a plurality of video sequences further comprises:
splitting the video content into the plurality of video sequences so that boundaries of each video sequence, of the plurality of video sequences, occurs at each scene cut.

23. The apparatus of claim 13, wherein execution of the one or more sequences of instructions cause iteratively creating video sequences by:
verifying whether a scene cut is present in an interval between the minimum and the maximum duration from a start of the video content or a start of the video content which has not been sequenced;
upon determining that the scene cut is present, creating a video sequence from the start of the video content, or the start of the video content which has not been sequenced, and the scene cut; and
upon determining that the scene cut is not present, creating the video sequence from the start of the video content, or the start of the video content which has not been sequenced, with a duration equal to the maximum duration.

24. The apparatus of claim 13, wherein execution of the one or more sequences of instructions cause:
upon a modification of the target coding time of the video content, modifying the computing capacities of all or a part of Operating-System-Level virtual environments based on the modification of the target coding time.

25. A method for scheduling execution of video processes on a cluster of physical machines, comprising:
splitting video content into a plurality of video sequences based on at least one of: a scene cut detection, a minimum duration, and a maximum duration, wherein said plurality of video sequences are to be coded on Operating-System-Level virtual environments executing in parallel;
calculating, for each video sequence, based on the video sequence and a target coding time of the video content, a target computing capacity of an Operating-System-Level virtual environment to code said each video sequence; and
instantiating, for each video sequence, an Operating-System-Level virtual environment of the target computing capacity on a physical machine in the cluster of physical machines.
